(19) United States
(12) Patent Application Publication
(10) Pub. No.: US 2010/0061834 A1
(43) Pub. Date: Mar. 11, 2010

(54) PLATFORM FOR CARRYING AND TRANSPORTING LOADS WITH AN UNROLLABLE FLOOR, AND TRANSPORT DEVICE WITH A PLATFORM OF THIS TYPE

(76) Inventor: Otto Roland Weich, Herrsching (DE)

Correspondence Address: FRASER CLEMENS MARTIN & MILLER LLC, 28366 KENSINGTON LANE, PERRYSBURG, OH, 43551, US

(21) Appl. No.: 12/441,304

(22) PCT Filed: Aug. 27, 2007
(86) PCT No.: PCT/EP07/58878

§ 371 Date: Mar. 13, 2009

(30) Foreign Application Priority Data
Sep. 15, 2006 (DE) 202006014414.5

(51) Int. Cl. B60P 1/38

(52) U.S. Cl. 414/489

(57) ABSTRACT

The present invention relates to a platform (12) for carrying and transporting loads, with a frame (16), with a chassis (20) at the front end of the platform (12), by means of which the platform (12) is moveable, with a revolving belt (26) which is guided on a closed, endless track in the frame (16) and with a bell drive (40) for the revolving belt (26), wherein the chassis (20) can be retracted and extended in order to lower and raise the front end of the platform (12). In addition, the present invention relates to a transport device (10) with a platform (12) of the abovementioned type and a transport vehicle (14) which can be coupled thereto.

The present invention relates to a platform for carrying and transporting loads comprising a frame, a chassis at the front end of the platform by means of which the platform can be moved, a circulating belt guided on a closed, endless track in the frame, and a belt drive for the circulating belt.

The invention further relates to a transport device having a platform of this type and a transport vehicle which can be coupled to said platform.

Because the circulating belt of the platform is guided on a closed, endless track; i.e. the base of the platform can roll, even heavier machines or order-picked goods can be unloaded by pulling the platform away from under the machine or order-picked goods. A transport vehicle additionally transports the loaded platform to its intended positional location. When at said location, the transport vehicle pulls the platform backwards. The belt drive can drive the roll-off base in the opposite direction to the direction of the platform's travel such that when the platform is being backed up, the movement of the platform is converted into an oppositely-directed roll-off motion of the rolling base at a 1:1 ration and the machine or other load cannot change its position relative the ground surface below upon the withdrawing of the platform and can be precisely positioned. The machine, the order-picked goods or other load thereby slowly slides forward on the rolling base off the platform.

A transport device having a platform for transporting and efficient unloading of material is known from U.S. Pat. No. 2,432,182. The base of the platform is formed by a plurality of rollers which extend almost the entire width of the platform and are held in a rectangular frame. The platform rests on lateral rails so that a transport vehicle in the form of a forklift can drive under the platform and lift it up. A forklift is used, the fork arms of which are equipped with a corresponding plurality of rollers. The rollers of the platform and of the forklift all have the same diameter and are arranged in the same pattern such that the rollers of the platform respectively position between two of the forklift rollers, thereby coupling the forklift to the platform. The forklift sets the platform down at an unloading point and drives backwards. The rollers of the forklift thereby roll back along the surface and transfer their rotational motion to the platform rollers so that the load on the platform rolls off from the platform. This roll-off movement is thereby the polar opposite to the backward motion of the forklift and the platform such that the load is kept in position relative the ground surface underneath it while it rolls off from the platform.

In a platform of the type indicated above known from WO 2000/039000, a gear or a drive chain drives the roll-off base via one or more friction rollers which can be configured as rigid heavy-duty rollers. A free-wheel and a clutch are disposed between the one or more friction rollers and the roll-off base. In order to be able to set the load down on the ground as smoothly as possible, a ramp is provided on the front and rear end of the platform to bridge the difference in height at that point and enable setting down the load without jolting it.

The present invention is based on the task of providing a platform with a roll-off base which will enable a load carried on the platform to be set down or unloaded with as little jarring as possible and precisely at a predetermined position.

The task is solved in accordance with the invention by a chassis being able to be extended and retracted in order to lower and raise the front end of the platform.

The chassis is preferably arranged as far forward as possible at the front end of the platform. This allows the platform to maneuver easily, also in the case of a relatively large surface area of e.g. 2.4×2.4 m, corresponding to the surface area of six standard transport pallets of 0.8×1.2 in.

The chassis is preferably pretensioned in the extended state so that it will retract upon load.

By the retracting of the front chassis, the platform is lowered almost completely to the ground surface on which to unload so that the load can be set down on the ground with virtually no jarring. A longer gravity incline is generally not necessary on the platform in order to enable the load to be set down jolt-free. This is advantageous because ramps are an obstacle to jolt-free loading and make maneuvering the platform more difficult. The outer dimensions of the platform also have to be larger and neither does a ramp constitute a usable part of the platform's surface area. A narrow bar or knife edge is however advisable on the front end of the platform to protect the circulating belt.

The belt drive can be integrated into the platform. An electric motor or a piston engine can thus be provided which is controlled by a positional sensor and drives the circulating belt opposite to the distance covered.

Preferably, however, a transport vehicle can be coupled to the rear end of the platform in fixed coupling to the vertical axis. This coupling is functionally tiltable about a horizontal axis is order to be able to adjust to ground surface irregularities.

The belt drive for the circulating belt or the roll-off base and the control for same are preferably arranged in the transport vehicle.

Generally speaking, the platform has a rectangular frame comprising two or more longitudinal bars connected by crossbars. The chassis, which is at the front end of the platform, can be integrated in the longitudinal bars and is retracted into the hollow space of said longitudinal bars upon the lowering of the platform.

An actuating mechanism for the chassis is provided to extend and retract it. The actuating mechanism can comprise an actuating cylinder or a spindle drive which acts on the chassis mechanism via a push/pull rod. The entire actuating mechanism can likewise be integrated into the platform. Preferably, however, the actuating cylinder is disposed on the transport vehicle while the push/pull rod runs through a longitudinal bar of the platform. The piston of the actuating cylinder or the spindle drive, aligning with the push/pull rod upon the coupling of the platform to the transport vehicle, couples to the end of the push/pull rod. Thus, also the extending and retracting motion of the chassis is preferably controllable from the transport vehicle.

Close to the front end of a longitudinal bar of the platform, the chassis can exhibit a double-arm angle lever pivotably mounted at the point of intersection of the two arms about an axis extending horizontally transverse to the direction of travel. The two angular arms form an angle of approximately 80 degrees. The longer angular arm points forward, with a pivotably-mounted single, double or tandem roller or an apron conveyor arranged at its free end. The push/pull rod acted upon by the actuating cylinder is articulated at the end of the shorter arm pointing rearward.

The chassis has one or more rollers depending on the platform's intended load capacity or, for very high loads and/or very uneven ground surface, an apron conveyor in place of the rollers. Tandem rollers are preferably utilized to realize a lower overall height. Two single or tandem rollers are generally sufficient up to a load capacity of approximately 2000 kg. When the platform is to have a greater load, an accordingly greater number of rollers can be provided. The maximum load is theoretically limited here by the properties and condition of the ground close to the chassis. The chassis rollers at the front end of the platform are generally not steerable.

The transport platform, its maximum load respectively, is generally determined by the nature of a freight truck and its loading platform. In this respect, it is advantageous to install profiled rails on the freight truck, its loading area respectively, or at another appropriate storage location for the transport platform removed from the transport platform chassis. This thus enables the transport rails to be either firmly attached to the loading area, etc., or also detachably attached to the transport platform so they can be laid out as needed.

The actuating mechanism for the chassis is preferably constructed such that the chassis is extended when not in operation. It is further preferred for the actuating mechanism to be designed such that the chassis retracts upon the platform being loaded and the platform lowers. This can be realized by a spring mechanism pretensioning the push/pull rod in the extended state of the chassis. To mechanically retract the chassis, the piston of the actuating cylinder or spindle drive pushes the push/pull rod forward, thereupon overcoming or neutralizing the initial tension. The pretensioning of the chassis in the extended state and the automatic retraction upon a given load on the platform guards against the platform being overloaded.

The pretensioning can be generated by a pressure spring arranged on the push/pull rod which braces against a stop inside the longitudinal bar and a stop on the push/pull rod. The rear end of the push/pull rod is situated in an opening at the rear end of the platform's longitudinal bar. When coupling the transport vehicle, it hereby suffices for the end of the push/pull rod to align with and in front of the piston of the actuating cylinder arranged on the transport vehicle, since the piston only needs to act to retract the push/pull rod; extending of the chassis is effected by the pretensioning when the piston pulls back.

There are two possible ways to lower the platform and retract the chassis:

The first possibility entails—as noted above—keeping the chassis extended by the push/pull rod via a pre-loaded spring. To retract, the piston of the actuating cylinder or the spindle drive butting the end of the push/pull rod pushes on the push/pull rod and supercompresses the preloaded spring of the chassis such that the chassis retracts and the platform lowers. To extend the chassis, the piston gives way so that the tensioning of the push/pull rod pushes the piston backward. Utilizing the pre-loaded spring also yields protection against overloading: when overloaded, the chassis retracts.

In the second possibility, the chassis is kept in its position by a locked push/pull rod. Tensioning is not provided. To lower, the locking disengages, the piston rod of the actuating cylinder gives way, and the chassis lowers accordingly. Lifting ensues in reversed order.

When unloading, the chassis at the front end of the platform is retracted so that the front edge of the platform comes into full or almost full contact with the ground and the load thus moves along a uniformly inclined plane at a substantially unvarying inclination and can ultimately be set down on the ground surface.

The rolling base or the circulating belt is preferably designed as a modular link conveyor. Said modular link conveyor consists of a plurality of chain links, each exhibiting two series of grommets respectively connected to the corresponding series of grommets of the adjacent chain link by means of a connector pin. The upper side of the modular link conveyor is even while the interconnected series of grommets form ribs on the underside.

The upper side of the frame is formed by a substantially closed sliding plate, the modular link conveyor lying atop said sliding plate. The material of the sliding plate is selected such that the combination of materials it produces with the material of the modular link conveyor has the lowest possible frictional coefficient. The material combination is usually dictated by the manufacturer of the modular link conveyor.

At the rear end, the modular link conveyor runs over a belt drive shaft or roller. The modular link conveyor is thereby driven by gearwheels which engage in the ribs on the underside of the modular link conveyor. These gearwheels are part of the belt drive shaft or roller at the rear end of the platform.

The modular link conveyor can likewise be deflected at the front end by such a shaft or roller or can also be directed around a freely-rotatable rod. For a modular link conveyor with a pitch of 12.7 mm, a rod having a diameter of 19 mm will suffice to effect the deflection. For a modular link conveyor of 10 mm thickness, the gradient at the rear end of the platform will thus only measure 39 mm in height.

A wedge can be disposed in front of the freely-rotatable rod around which the modular link conveyor is directed at the front end to bridge the remaining gradient. The wedge concurrently constitutes protection for the area. It can be formed from a bent steel plate, for example.

Instead of the freely-rotating rod, a knife edge can also be provided around which the modular link conveyor is pulled. Although greater friction occurs in this case versus deflecting around a freely-rotating rod. In order to obtain an interlocking drive for the circulating belt with the gearwheels via the belt drive shaft or roller arranged at the rear area of the platform, the circulating belt needs to be slightly taut.

The belt drive can be effected by a motor integrated into the platform. Preferably, however, the belt drive is also integrated into the transport vehicle. The transfer of the drive power from the transport vehicle to the coupled platform is functionally provided by a gearwheel on the transport vehicle meshing with a gearwheel on the platform when the platform is coupled to the transport vehicle.

The platform-side gearwheel of the belt drive is situated either directly on the belt drive shaft or on its own intermediate shaft located below the belt drive shaft, whereby the actual belt drive shaft is then driven by a lateral pair of gears in the supporting bars. If the platform-side gearwheel is situated on the belt drive shaft, the circulating belt needs to be interrupted at this point. This interruption is not necessary when the platform-side gearwheel is situated on its own intermediate shaft.

Depending on the width of the platform, the roll-off base or the circulating belt comprises one or a plurality of adjacent modular belts. The circulating belt stretches out in operation and therefore the distance between the front deflection mechanism (roller, cylinder, rod or knife edge) and the rear deflection mechanism (belt drive shaft or roller) needs to be adjusted. To this end, a base inserted in the platform frame is spilt lengthwise, perpendicular to the belt's direction of conveyance. An eccentric or a splined strip is inserted into the base's hollow space. Eccentrics or splined strips can be manipulated from the outside. The base can thereby be stretched somewhat and the belt thus adjusted.

The transport vehicle preferably comprises one or a plurality of steerable drive rollers and one or a plurality of free-wheel supporting wheels which can alternatively function as freely-moveable steering rollers or can be locked in the straight-ahead position. In the simplest case, the transport vehicle has two front supporting wheels and a rear, steerable drive wheel. The two front supporting wheels are functionally configured as steering rollers which can preferably be fixed. When the transport vehicle is coupled to the platform, the front steering rollers will thus pivotably position the transport vehicle so that the steering geometry is formed by the chassis at the front end of the platform and the rear drive and steering wheel of the transport vehicle. On the other hand, when the transport vehicle is uncoupled from the platform to drive by itself, its two front steering rollers will be aligned and fixed with the wheel axle perpendicular to the longitudinal axis of the transport vehicle. The transport vehicle can then be driven like any standard industrial truck.

To couple the platform to the vehicle, the vehicle engages by means of centering bars in the corresponding recesses for the centering bars configured on the platform. The centering bars are configured such that the platform is in horizontal and vertical alignment when raised. To this end, the centering bars of the transport vehicle can be designed to be vertically adjustable. The vertical adjustment can be effected by hydraulic cylinders or a spindle drive.

Two lateral hook ties are provided on the transport vehicle which engage in the corresponding retaining brackets on the platform. The hooks can be pulled back via hydraulic cylinders or spindle drives so that the platform is braced against the transport vehicle. After the raising and centering of the centering bars at the interface with the transport vehicle, the platform has to be pressed and held against same. The vehicle-side and platform-side drive gearwheel of the belt drive thereby engage. During this process, the vehicle-side gearwheel is kept in rotation in order to ensure the interlocking of the gearwheels.

In the coupled state of the transport vehicle and platform, a hinging movement is preferably also possible about a horizontal axis. This can be realized, for example, in that the centering bars taper vertically to the tip or the centering bar receiving elements are correspondingly widened so that while the centering bars are fixed at the rear end of the platform, their tips nevertheless have vertical play. Another possibility would be configuring the centering bars to be pivotable, whereby they are pretensioned in a somewhat horizontal beating so that they make contact with the receiving elements at the rear end of the platform upon coupling. The vehicle-side gearwheel of the belt drive is in this case moveable and pretensioned toward the platform such that there is always engagement with the platform-side gearwheel in the coupled state.

Another further possibility entails centralizing all the vehicle-side mechanisms of the belt drive and the actuation of the chassis in one function box which can be fixedly coupled to the rear end of the platform and is articulated to be pivotable about a horizontal axis and vertically displaceable on the transport vehicle.

Steering rollers can be provided at the rear end of the platform so that the platform can also be moved manually or by any type of tractor if need be. Extendable or pull-out supports can additionally be provided on the four corners of the platform, in particular at the rear corners. This allows the platform to be securely transported in the loading area of a truck.

In order to be able to load a truck, for example, the platform needs to be capable of millimeter-exact maneuvering. To this end, the transport vehicle couples at the rear end of the platform and raises the back of the platform; the platform is supported in the front by the chassis. Since in so doing, the chassis of the platform and the rear drive and steering wheel of the transport vehicle form the steering geometry of the transport device, millimeter-exact maneuvering becomes possible. Since the chassis of the platform is positioned as close to the front end as possible, the front end of the platform basically does not swerve or sway out when cornering. The horizontal articulation neutralizes any unevenness of the driving surface between the platform chassis and the transport vehicle chassis. The horizontal compensating joint can also be achieved by a specific implementation of the centering bar.

Further options for the transport device are as follows:
Instead of a freely-movable transport vehicle, the platform is coupled to a mechanically-controlled telescopic arm which moves the platform and pushes it e.g. onto the loading area of a truck.
As an enhancement, a plurality of platforms are positioned behind one another on a transport belt and transferred by means of a telescopic arm, whereby an unloaded platform is first passed to a second conveyor belt beside it.
Permanent installation on the hydraulic lift of a truck having a lowerable floor plate.

Reference will be made in the following to the drawings in describing an embodiment of the invention in greater detail. Shown are:

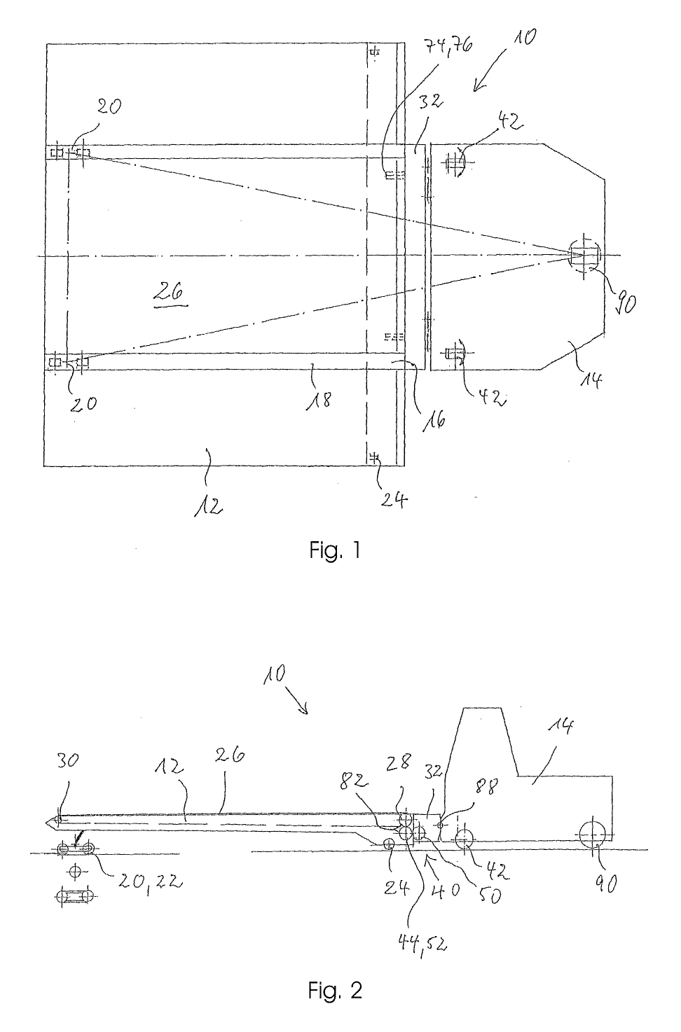

FIG. 1: a top plan view of the platform with roll-off base;

FIG. 2: the platform of FIG. 1 as seen from the side;

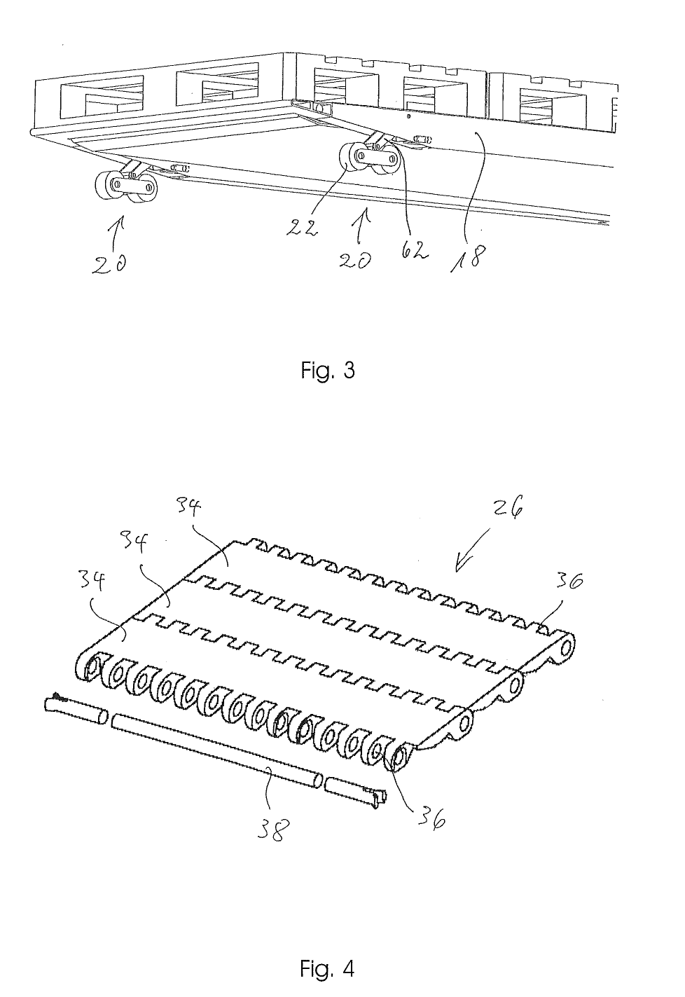

FIG. 3: the front end of the platform of FIG. 1 as seen from below;

FIG. 4: a detail of a modular link conveyor in stereoscopic depiction;

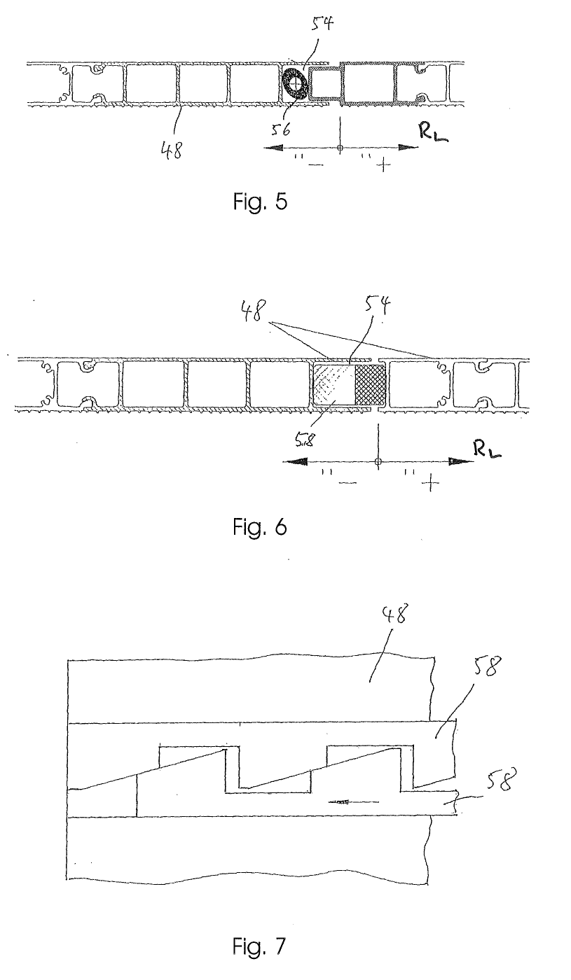

FIGS. 5, 6 and 7: the longitudinal adjustment of the platform to tighten the circulating belt;

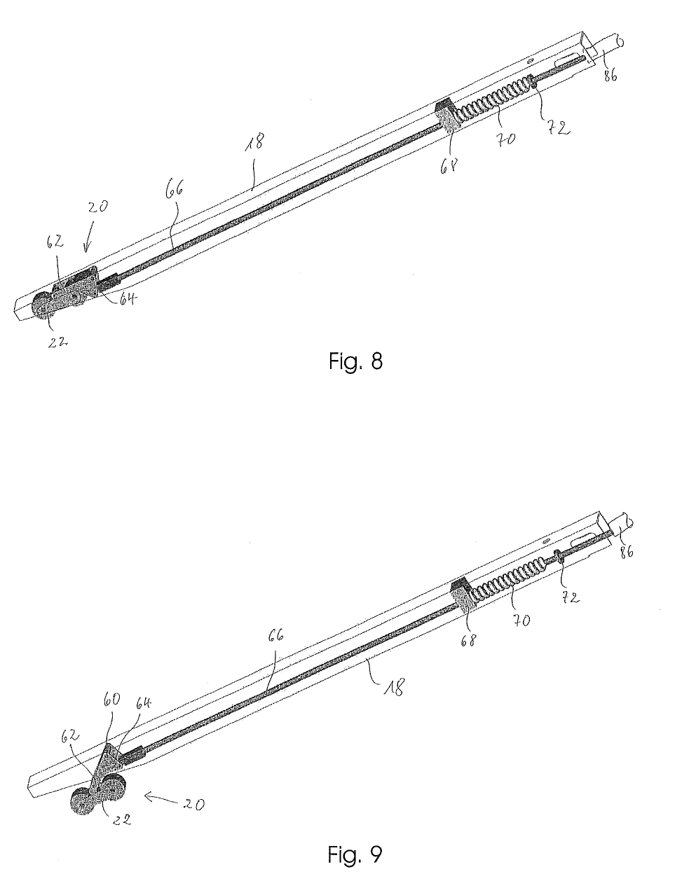

FIG. 8: a longitudinal bar having a mechanism to extend and retract the chassis, whereby the chassis is extended;

FIG. 9: a longitudinal bar having a mechanism to extend and retract the chassis, whereby the chassis is retracted;

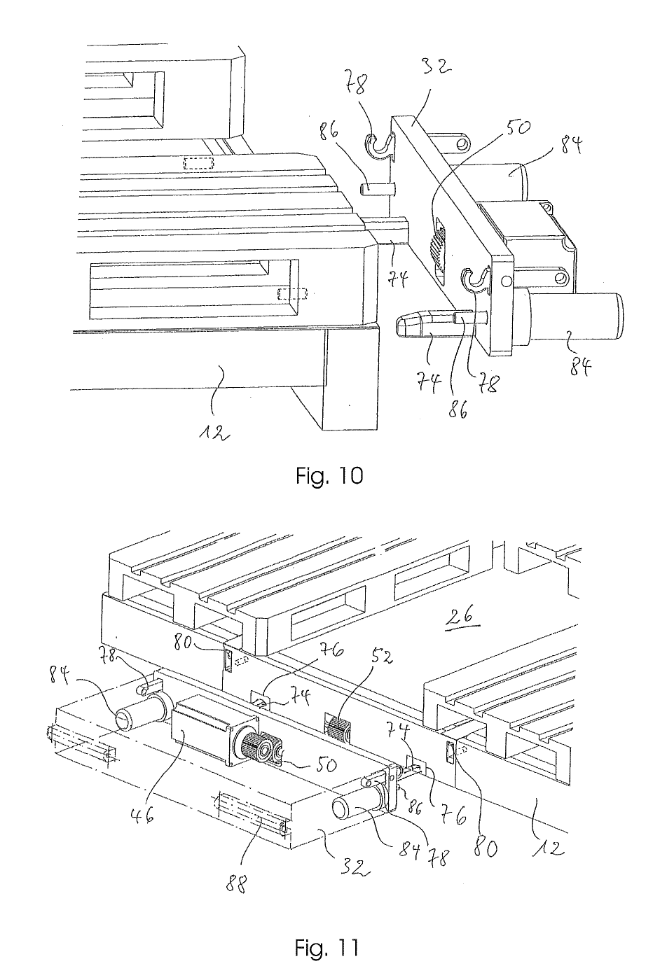

FIG. 10: the function box and the rear area of the platform diagonally from the front;

FIG. 11: the function box and the rear area of the platform diagonally from the rear;

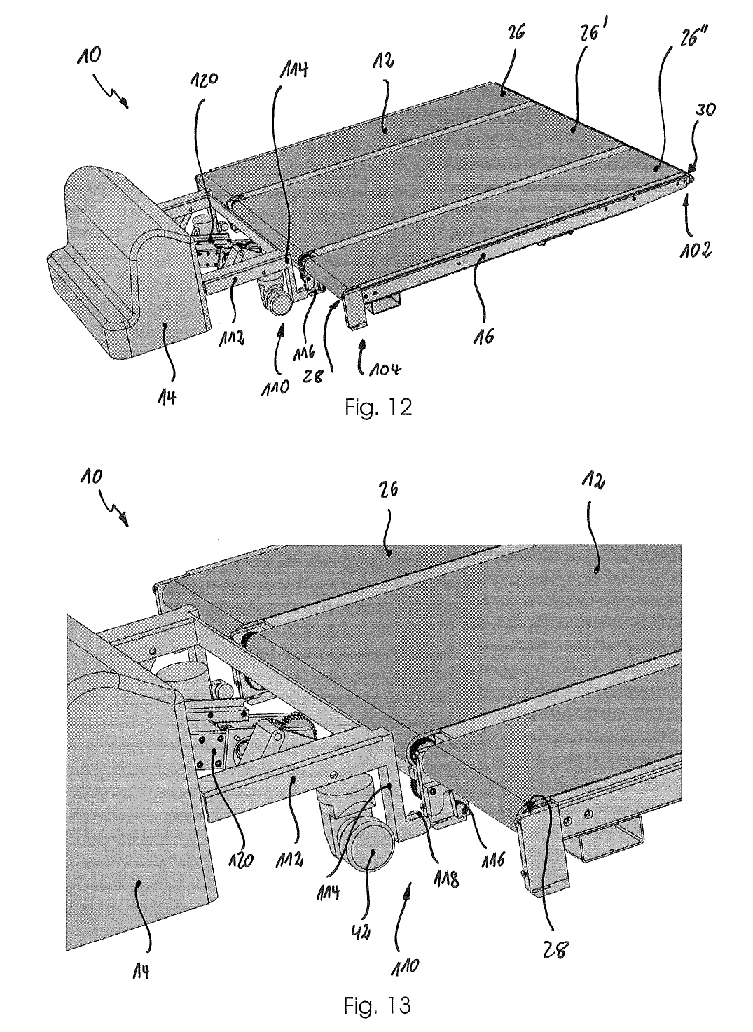

FIG. 12: an isometric representation of a further embodiment of the transport device;

FIG. 13: an isometric detail representation of a coupling device for the embodiment shown in FIG. 12;

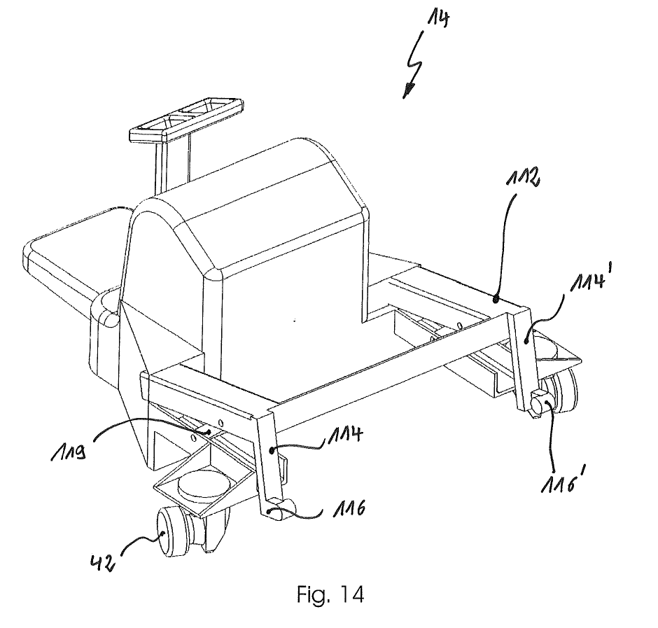

FIG. 14: an isometric representation of the transport vehicle of the embodiment shown in FIG. 11;

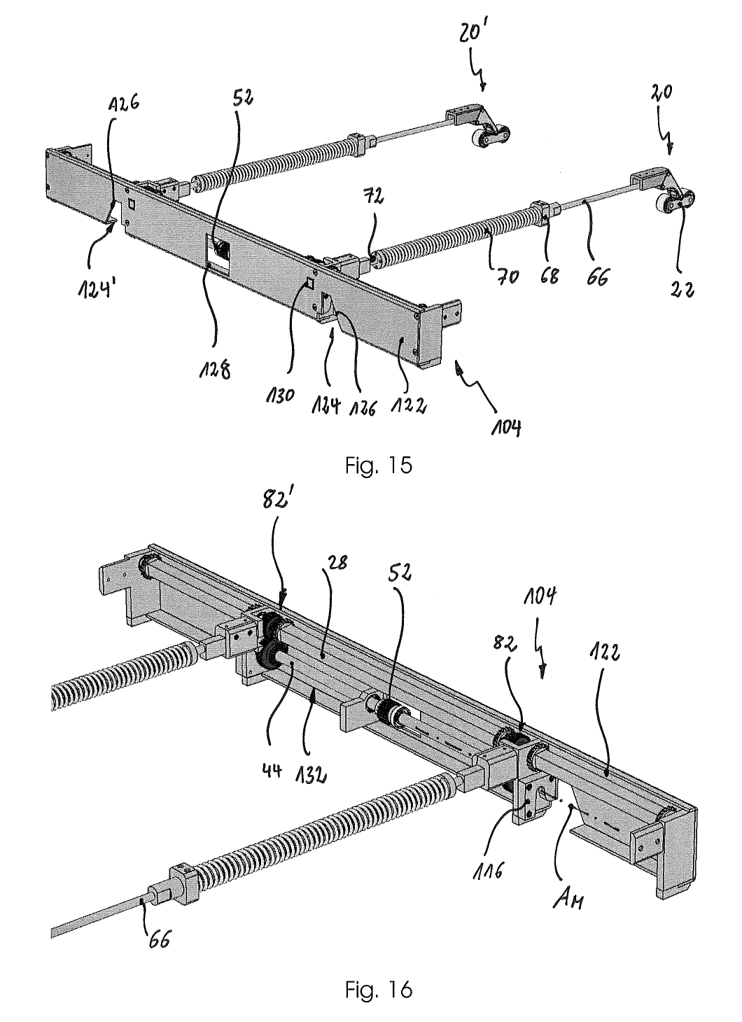

FIG. 15: an isometric detail representation of the coupling region of the transport platform;

FIG. 16: an isometric representation of the belt drive of the transport platform;

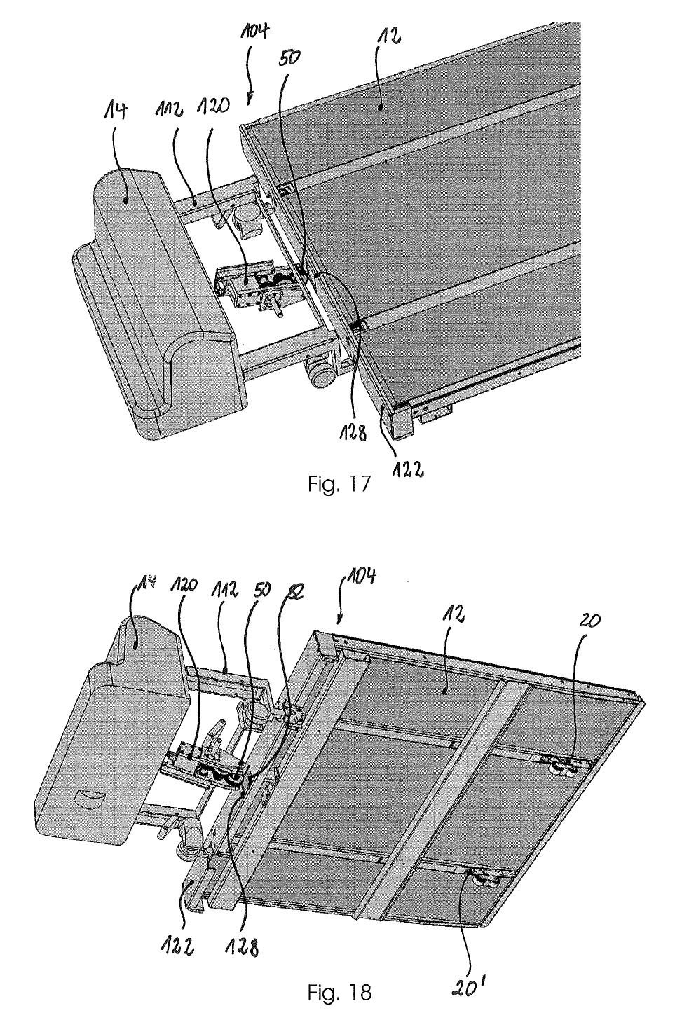

FIG. 17: an isometric representation of the transport device and its belt drive device as seen diagonally from above;

FIG. 18: an isometric representation of the transport device and its belt drive device as seen diagonally from below;

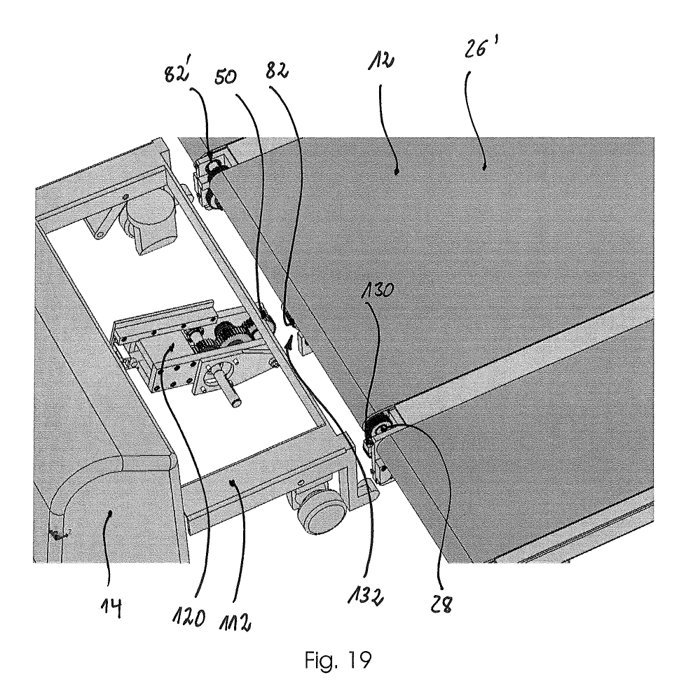

FIG. 19: an isometric detail representation focussing on the belt drive device shown in

FIG. 17; and

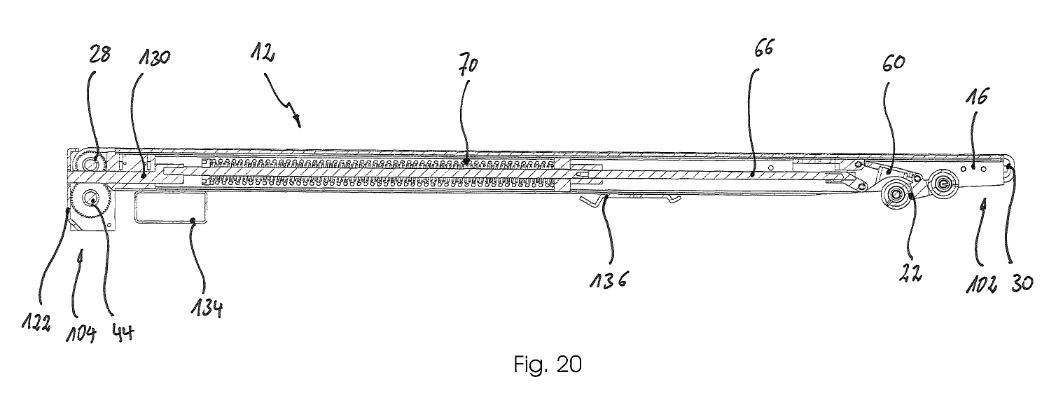

FIG. 20: a cross-section through the embodiment of the transport platform according to FIG. 12.

FIGS. 1 and 2 show an embodiment of an inventive transport device 10. The transport device 10 is comprised of a platform 12 and a transport vehicle 14. The platform 12 can be coupled to the transport vehicle 14.

The platform 12 has a flat, rectangular frame 16 with lateral longitudinal bars 18 and crossbars. A retractable and extendable chassis 20 is provided at the front end of the frame 16. The chassis 20 can, as FIG. 1 depicts, exhibit a tandem roller 22. The tandem roller 22 cannot be steered. Given a lesser load on the platform 12, a chassis 20 can also have a single roller or, at a particularly high loading, same can be provided with an apron conveyor, as is presented in FIG. 2 as an alternative.

Additional, steerable if need be, free-wheel rollers 24 can be provided in the rear area of platform 12. The platform 12 can then be moved with conventional tractors or also manually, thus independently of the transport vehicle 14.

A modular link conveyor 26 which functions as a circulating belt and rolling base, is guided on a closed circulating track in frame 16. The modular link conveyor 26 essentially extends the entire length of the platform 12. The modular link conveyor 26 is guided over a belt drive shaft 28 at the rear end of platform 12. At the front end, it is guided over a freely-rotatable deflecting rod, a similar deflecting roller 30, or a knife edge. Sliding plates are positioned on the frame 16 on which slides the upper strand of the modular link conveyor 26.

The transport vehicle 14 can be, for example, a standard industrial truck equipped with lockable steering rollers 42—as will be described in detail below—and with a hydraulic or electrical power train or another suitable power supply. A function box 32 is mounted at the front of the transport vehicle 14 which comprises the mechanisms necessary to couple to the platform 12 in order to drive the circulating belt 26 or the rolling base and extend and retract the chassis 20.

The individual components of the transport device 10 will be described below in detail:

The modular link conveyor 26 is comprised of a plurality of chain links 34 having a series of interspaced grommets 36 along the respective front and rear edge (FIG. 4). The grommets 36 of one chain link 34 series are offset relative the grommets 36 of the other series of the same chain link 34, and the width of the grommets 36 is equal to their respective spacing so that the one series of grommets of a chain link interconnects with a series of grommets of the preceding or following chain link 34 and can be connected by means of a connector pin 38 which is pushed through the aligning grommets 36 of the preceding and following chain link 34. The two series of grommets of each chain link 34 are connected by a tangentially-arranged web of the grommets 36 so that the upper side of the modular link conveyor 26 is even while the grommets 36 on the underside form transverse ribs. The ribs engage with the sprockets of belt drive shaft 28. The ribs also enable the modular link conveyor 26 to slide along the sliding plate. The deflecting roller 30 at the front end of the platform 12 is of cylindrical shape. The diameter of deflecting roller 30 is as small as possible and corresponds approximately to the pitch of the modular link conveyor 26. The height of the gradient at the front end of the platform 12 can thereby be kept very low.

A belt drive 40 transfers the traveling motion of the transport device 10 to the modular link conveyor 26 such that the upper strand of the modular link conveyor 26 appears to be still and not moving relative the ground surface. The belt drive 40 comprises a positional determining device. One of the free-wheels or rollers 42 of the transport vehicle can function, in conjunction with an angular rotation sensor, as a positional determining device. The displacement signal of the angular rotation sensor controls the belt drive 40 such that when the platform 12 is pulled back, the modular link conveyor 26 is driven at the same speed in the opposite direction of travel, whereby a load atop the modular link conveyor 26 does not change its position relative the ground surface and is ultimately set onto the ground over the front edge of the platform 12.

A drive mechanism 46 of the belt drive 40 is arranged for this purpose inside the function box 32 and draws its operating power from an electric motor supplied by a battery of the transport vehicle 14 or from the hydraulic mechanism of the transport vehicle 14. The belt drive exhibits a vehicle-side gearwheel 50 driven by the drive mechanism 46, the periphery of which is partly exposed at the front end of the function box 32. When the platform 12 is being coupled to the transport vehicle 14, this gearwheel engages with a platform-side gearwheel 52 at the rear end of platform 12, whereby said gearwheel 52 is drive-connected to the modular link conveyor 26. The platform-side gearwheel 52 of the belt drive 40 is situated underneath the belt drive shaft 28 on an intermediate shaft 44 which drives the belt drive shaft 28 by means of a lateral pair of gearwheels 82 (FIG. 2).

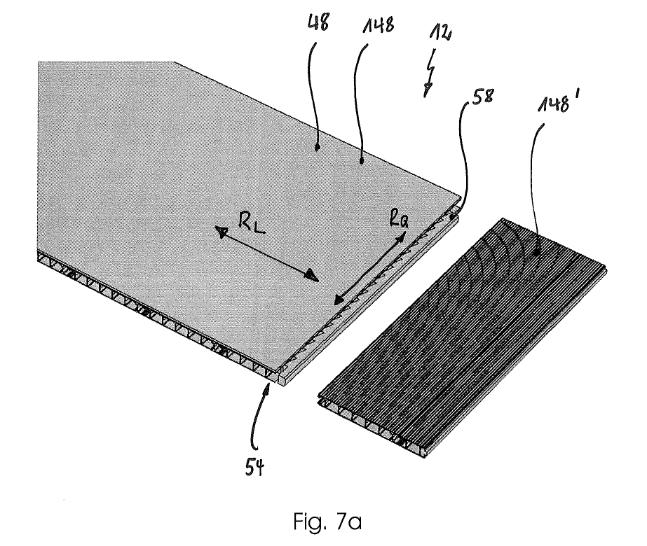

The belts stretch out in operation and need to be able to be adjusted from time to time. For this purpose, the base 48 positioned in the platform frame 16 is split lengthwise, at right angles to the conveying direction of the belt 26. An eccentric 56 (FIG. 5) or a splined wedge strip 58 (FIGS. 6 and 7) is positioned in a hollow space 54 at the location of the split of the profiled base. The eccentric 56 or splined strip 58 can be manipulated from the outside. While the belt drive shaft 28 is fixedly mounted in the frame 16, the deflecting roller 30 is mounted to the foremost element of the positioned base 48 and is moved together with same. Turning the eccentric 56 or moving the opposing-splined strip 58 results in some degree of stretching of the positioned base 48 as a whole and thus retightening of the belt 26.

FIG. 7A shows an isometric representation of this length-variable transport platform 12 in a diagonal view from above. Depicted is the base 48 which is split into two base sections 148 and 148′. The hollow honeycomb structure to base 48 and a corresponding section cut forms a hollow space 54 in this embodiment which serves to receive the splined wedge strip 58. In accordance with the invention, this splined wedge strip can now adjust the length of the transport platform 12, base 48 respectively, within a certain range and thus react to the change in length of the transport belt (not shown). By virtue of the individual opposing-splined components of wedge strip 58, their displacement in a transverse direction R_{Q} can change the distance between the two base sections 148; 148′ in longitudinal direction R_{L}. It is to be noted in conjunction hereto that it is possible to automate the above length adjustment by means of appropriate regulating elements and appropriate sensors so as to always ensure a required tension for belt 26. For example, an eccentric can be equipped with a rotational position device controlled by tension sensors on belt 26 so the eccentric can thereby be turned back and forth based on the detected tension.

FIGS. 3, 8 and 9 show a longitudinal bar 18 in which the mechanism for the retracting and extending of the chassis 20 is integrated. The longitudinal bar 18 has a rectangular profile configured at its front end as a U-profile open downward such that its underside is open to chassis 20. A double-arm angle lever 60 is mounted at the front area of the longitudinal bar 18. The two angular arms 62 and 64 of angle lever 60 form an angle of approximately 80 degrees and the angle lever 60 is mounted at the intersecting point of said two angular arms 62 and 64. The forward-facing angular arm 62 is approximately two or three times longer than the rearward-facing angular arm 64.

The tandem roller 22 is mounted at the free end of forward-facing angular arm 62. The free end of the rearward-facing angular arm 64 is articulated to a push/pull rod 66 which extends through a guide 68 to the rear end of longitudinal bar 18. A pressure spring 70 is seated on the push/pull rod 66 which is braced against the rear of guide 68 and a stop 72 on the push/pull rod 66 and thereby pretensions the push/pull rod 66 rearward so that the chassis 20 is normally extended (FIG. 8). Subjecting the rear end of the push/pull rod 66 to a force which overcomes the initial tension allows the chassis 20 to retract (FIG. 9).

FIGS. 10 and 11 show the rear end of platform 12 and, at a slight distance therefrom, the function box 32. Two centering bars 74 extend forward from function box 32. They are received in the corresponding centering bar receiving elements 76 when coupling. The receiving element 76 of the centering bar and the centering bar 74 itself are mated to one another with very little play. Hook ties 78 are further provided on the sides of the function box 32 which engage with brackets 80 in the recesses at the rear end of platform 12 such that the platform 12 is fixedly coupled to the function box 32. The hook ties 78 are moved and tensioned by hydraulic cylinders or spindle drives (not shown).

During the coupling process, the vehicle-side drive gearwheel 50 for the circulating belt 26 and the platform-side gearwheel 52 engage. The vehicle-side drive gearwheel 50 is held in rotation during the coupling in order to ensure engagement of gear-wheels 50, 52. In the coupled state, the vehicle-side gearwheel 50, mounted in the function box 32, and the platform-side gearwheel 52 then engage. The platform-side gearwheel 52 sits on the intermediate shaft 44 (FIG. 2), its rotation transferring to the belt drive shaft 28 via a lateral pair of gears 82. The vehicle-side gearwheel 50 is driven by the drive mechanism 46 on the vehicle 20 and thus drives the modular link conveyor 26 via this gear train.

While the function box 32 is fixedly pressed to the platform 12 in the coupled state, the function box 32 is articulated to transport vehicle 14 (articulation 88) so as to still enable a limited tilting motion about a horizontal axis and the transport device 10 consisting of platform 12 and transport vehicle 14 can adjust to ground irregularities.

The function box 32 is secured to the transport vehicle 14 to be height-adjustable. The height adjustment is realized by hydraulic cylinders or a spindle drive. The maximum lift is relatively small and only selves to lift the tear end of the platform 12 somewhat off the ground in order for the platform to be able to travel.

Actuating cylinders 84 are further provided in the function box 32, the pistons 86 of which engage in the rear ends of the push/pull rods 66 in the coupled state of vehicle 14 and platform 12. By the pistons 86 of the actuating cylinder 84 subjecting the rear ends of the push/pull rods 66 to enough force, the initial tension of the push/pull rods 66 can be overcome and the vehicle 20 retracted.

The inventive platform 12 serves to facilitate loading and to save time in transporting and order picking. In loading, the front chassis 20 is extended and sets the platform 12 on the rear end of the frame 16 so that the platform 12 is level. The platform 12 can be stocked by means of forklifts, hoisting equipment or hand trucks in the usual way. Loading can, of course, also be performed by a loading robot.

When the platform 12 is fully loaded and is to be driven e.g. onto the loading area of a truck, the transport vehicle 14 couples to the platform 12, lifts the rear end of the platform 12, and drives the platform 12 onto the loading area of the truck. Whereby the chassis 20 is naturally extended. The payload can be transported on the truck to the intended destination together with the platform 12 or without the platform.

In the first case, the transport vehicle 14 uncouples from the platform 12 on the truck, which couples to another transport vehicle 14 at the intended destination, pulls the platform 12 from the truck, and drives it for example to a predetermined location within the warehouse. There, by means of the actuating cylinder 84, the chassis is retracted and the front end of the platform 12 is thereby lowered to the ground. The belt drive 40 is then activated and the platform 12 pulled back. The belt drive 40 is thereby controlled by the positional determining device so that the modular link conveyor 26 is driven at the exact same speed, albeit in the opposite direction, whereby the platform 12 is pulled back from the transport vehicle. The payload is thereby unloaded exactly at its intended location.

In the second case, the platform 12 has already been pulled back from the transport vehicle 14 by the truck's loading area. The platform 12 is hereto lowered and the belt drive 40 with the positional determining device activated so that the payload on the truck's loading area can be set down at the exact intended location.

The chassis 20 at the front end of the platform 12 and the rear drive and steering wheel 90 of the transport vehicle 14 then form the steering geometry of the transport device 10. What is distinctive, however, is that the horizontal axis of the articulation 88 can counterbalance irregularities in the driving surface between the chassis 20 of the platform 12 and the chassis 42, 90 of the transport vehicle 14. The front free-wheel supporting wheels 42 of the transport vehicle are thereby released so that they can function as freely-moving steering rollers.

When the transport vehicle 14 is uncoupled from the platform 12, the supporting wheels 42 are aligned and fixed such that their wheel axles are perpendicular to the longitudinal axis of the transport vehicle 14. The transport vehicle 14 can then be driven like any standard industrial truck.

FIG. 12 shows an isometric representation of a further embodiment of transport device 10. This configuration is shown in detail in FIG. 13 focussing on a coupling device 110.

Shown are a transport vehicle 14 and the transport platform 12 coupled thereto. The transport platform 12 here comprises three parallel-extending belts 26 configured to circulate between a front end 102 and a rear end 104. To support the belts 26, the transport platform 12 exhibits a belt drive shaft 28 and a deflecting roller 30 which are kept substantially parallel to one another in a frame 16. The belt drive shaft 28 can, as will be described in greater detail below, be driven by a corresponding vehicle-side belt drive device 120.

As with the preceding embodiment, the transport device 10 shown here comprises an extendable chassis 20 (see FIGS. 15 and 18), arranged in the area of the front end 102. At the rear end 104, the transport platform 12 can be coupled to the transport vehicle 14 by means of a coupling device 110. Said coupling device comprises a lifting frame 112 on which lifting arms 114 are configured which can be brought into interacting connection with the receiving pockets 116 on the transport platform 12 such that the rear end 104 of the transport platform 12 can be lifted and lowered.

The coupling in this embodiment is moreover realized such that the transport platform 12, pivotable about a horizontal axis relative the transport vehicle 14, is fixedly coupled to the transport vehicle 14 about a vertical axis; i.e. an axis perpendicular to the transport platform 12. After coupling, the transport vehicle 14 and the transport platform 12 can be navigated as one unit, in particular by the lockable steering wheels 42 arranged on transport vehicle 14.

The coupling device 110 comprises the above-cited lifting arms 114 arranged on the lifting frame 112 of transport vehicle 14. Pick-up mandrels 118 extending congruently to the receiving pockets 116 on the transport platform 12 are configured on the lifting arms 114. When coupling the transport vehicle 14 to the transport platform 12, the pick-up mandrels 118 slide into the receiving pockets 116 and lock when the lifting arms 112 are raised so that the transport platform 12 is securely coupled to the transport vehicle 14.

FIG. 14 shows the transport vehicle 14 schematically and in an isometric representation. Identifiable here is the lifting frame 112, constructed here to be substantially symmetrical, and comprising the lifting arms 114, on which the essentially orthogonal forward-projecting pick-up mandrels 116 are formed. Said forked lifting frame 112 with its lifting arms 114 can be pivoted upward and downward via adjusting mechanism 119 so as to raise and lower, respectively couple and uncouple, the transport platform 12 (see FIG. 13).

In FIGS. 15 and 16, a section, individual components respectively, of the transport platform 12 have been cut out and illustrated in detail; specifically of an end plate 122 positioned at the rear end 104 of the transport platform (see FIG. 17). The end plate 122 in this embodiment exhibits two center openings 124 which serve the lateral centering of the transport platform relative the transport vehicle 14 when coupling. When connecting the transport platform 12 to the transport vehicle 14, the vehicle-side pick-up mandrels 118 (see FIG. 14) engage through the center openings 124 in order to lock in place with the platform-side receiving pockets 116. Due to the geometric configuration of the center openings 124 here, in particular the pitched lateral edges 126, the pick-up mandrels 118 (see FIG. 14) are guided to fit precisely into the receiving pockets 116 of the transport platform.

A drive opening 128 is further depicted on the end plate 122, offering access to a platform-side gearwheel 52 and associated drive system for the transport platform and in particular for the chassis 20 of transport platform 12. This detail will be addressed in more specific terms below.

FIG. 15 schematically depicts hereto the chassis construction of the transport platform 12. It encompasses two chassis 20, each comprising a tandem roller 22, which are retractable and extendable by means of push/pull rods 66. The push/pull rods 66 have pressure springs 70 for this purpose which are pretensioned against a guide 68 and a stop 72 so that the chassis 20 is retracted. By means of an ejector 130 likewise accessible through the end plate 122, the initial tension applied by the pressure spring 70 can be overcome and the chassis 20 extended. In conjunction hereto, reference is expressly made to the above-described embodiment and the respective procedure for retracting and extending the chassis; same also applies here.

FIG. 16 now shows the representation of FIG. 15 from the rear and likewise in a schematic isometric depiction. The end plate 122 is depicted here as well, arranged on the rear end 104 of transport platform 12. The end plate 122 covers the platform-side belt drive device 132 serving to drive the belts 26 (see FIG. 12).

Illustrated hereto is an intermediate shaft 44 comprising the platform-side gearwheel 52 by means of which the platform-side belt drive device 132 is driven by the transport vehicle 14. By means of the lateral pair of gears 82, the drive force of the transport vehicle 14 is also transferred here from the intermediate shaft 44 to the belt drive shaft 28 which drives belt 26 (see FIG. 12). Relevant hereto is that the rotational axis of the intermediate shaft 44 runs coaxially to the central axis A_{M} of the receiving pockets 116.

FIG. 17 now again shows the embodiment from FIG. 12 in an isometric representation, whereby special attention is focussed here on the vehicle-side belt drive device 120. This vehicle-side belt drive device 120 is substantially comparable to the function box 32 described above (see FIGS. 10 and 11); it is likewise arranged to be pivotable on transport vehicle 14 and here within the lifting frame 112. By pivoting about a substantially horizontal axis; i.e. here an axis parallel to the transport platform 12, the vehicle-side belt drive device 120 and a vehicle-side drive wheel 50 arranged thereon can be pivoted into the drive opening 128 of the end plate 122 so that the vehicle-side drive wheel 50 operatively interacts with the platform-side drive gearwheel 82.

The functioning of this drive device, the vehicle-side drive device 120 and the platform-side belt drive device 132 respectively, is depicted in greater detail in FIG. 18. Identifiable are the two gearwheels 50; 82 which operatively interact upon the pivoting of the vehicle-side belt drive device 120 so that the rotational forces are transferred to the intermediate shaft 44 and from there via the lateral gear pair 82 to the belt drive shaft 28 and from there to belt 26.

The above embodiment of the transport platform 12 is depicted in a side view in FIG. 20. Again identifiable is the frame 16 comprising both the deflecting roller 30 at front end 102 as well as the belt drive shaft 28 and the intermediate shaft 44 at rear end 104.

Again depicted are the two transverse connectors 134 and 136 which offer the inventive transport platform 12 both reinforcement from a structural standpoint as well as the seating ability for a conventional forklift to, for example, pick up the transport platform 12 in a transverse direction and transport same.

Moreover recognizable in FIG. 19 is the chassis 20 of the transport platform 12. It comprises in known manner the tandem rollers 22 which are connected to the trans-port platform 12 via an angle lever 60. The chassis 20 can be extended and retracted by means of a push/pull rod 66 pretensioned by a pressure spring 70. The ejector 130 is provided for the extending; it runs through the end plate 122 and can be activated for example by means of a corresponding hydraulic actuator on transport vehicle 14 (not shown).

### LIST OF REFERENCE NUMERALS

10 transport device
12 platform
14 transport vehicle
16 frame
18 longitudinal bar
20 chassis
22 tandem roller
24 steering roller
26 modular link conveyor
28 belt drive shaft
30 deflecting roller
32 function box
34 chain link
36 grommets
38 connector pin
40 belt drive
42 free-wheel
44 intermediate shaft
46 drive mechanism
48 base
50 vehicle-side gearwheel
52 platform-side gearwheel
54 hollow space
56 eccentric
58 wedge strip
60 angle lever
62 front angular arm
64 rear angular arm
66 push/pull rod
68 guide
70 pressure spring
72 stop
74 centering bar
76 centering bar receiving element
78 hook ties
80 bracket
82 gear pair
84 actuating cylinder
86 piston
88 articulation
90 drive and steering wheel
102 front end
104 rear end
110 coupling device
112 lifting frame
114 lifting arm
116 receiving pocket
118 pick-up mandrel
119 adjusting mechanism
120 vehicle-side belt drive device
122 end plate
124 center opening
126 lateral edge
128 drive opening
130 ejector
132 platform-side belt drive device
134 transverse connector
136 transverse connector
148 base section
A_{M} central axis
R_{Q} transverse direction
R_{L} longitudinal direction

1. A transport device (10) comprising
a platform (12) for carrying and transporting loads comprising a frame (16);
a chassis (20) at the front end of the platform (12) by means of which the platform (12) can be moved;
a circulating belt (26) guided on a closed, endless track in the frame (16), and a belt drive (40) for the circulating belt (26);
wherein the chassis (20) is retractable and extendable in order to lower and raise the front end of the platform (12); and
a transport vehicle (14) couplable thereto which comprises one or a plurality of steerable drive rollers (90) and one or a plurality of free-wheel supporting wheels (42) which can alternatively function as freely-moveable steering rollers or can be locked in the straight-ahead position.

2. The transport device according to claim 1, wherein the chassis (20) is pretensioned in an extended state so that the chassis (20) will retract upon load.

3. The transport device according to claim 1, further comprising a coupling disposed on a rear end of the platform (12) for coupling a transport vehicle (14) thereto, the coupling substantially rigid relative to a vertical axis.

4. The transport device according to claim 3, wherein the coupling is tiltable about a horizontal axis (88).

5. The transport device according to claim 1, wherein a drive mechanism (46) of the belt drive (40) for the circulating belt (26) and a control for same are arranged in the transport vehicle (14).

6. The transport device according to claim 1, wherein the extending and the retracting of the chassis (20) is controllable from the transport vehicle (14).

7. The transport device according to claim 1 wherein the platform (12) comprises at least one length adjusting element (56;58) for adapting a longitudinal extension of the platform (12) and in particular for adapting an elongation of the circulating belt (26).

8. The transport device according to claim 7, wherein the length adjusting element (56;58) is arranged between two adjacent platform base sections (148;148′).

9. The transport device according to claim 7, wherein the length adjusting element (56;58) is an eccentric (56) or an opposing-splined wedge strip (58).
